(19) United States
(12) Patent Application Publication
(10) Pub. No.: US 2011/0310384 A1
(43) Pub. Date: Dec. 22, 2011

(54) METHODS AND SYSTEM FOR CONFOCAL LIGHT SCATTERING SPECTROSCOPIC IMAGING

(76) Inventors: Irene Georgakoudi, Acton, MA (US); Pong-Yu Huang, West Roxbury, MA (US); Martin Hunter, Bradford, MA (US)

(21) Appl. No.: 13/139,953

(22) PCT Filed: Dec. 22, 2009
(86) PCT No.: PCT/US09/69196

§ 371 Date: Sep. 12, 2011

Related U.S. Application Data
(60) Provisional application No. 61/140,160, filed on Dec. 23, 2008.

(51) Int. Cl. G01J 3/28

(52) U.S. Cl. 356/326

(57) ABSTRACT

The present invention is generally directed to imaging methods and apparatus that employ angular and/or wavelength distribution of light backscattered from multiple portions of a sample in response to illumination by electromagnetic radiation to generate one, two or three dimensional images of the sample. In many embodiments, confocal imaging can be employed to detect the backscattered radiation, e.g., to measure spectral signals of layered samples (such as biological samples) through optical sectioning. The methods of the invention can be applied to a variety of samples including, without limitation, biological and non-biological samples, organic and inorganic samples, to obtain information, e.g., regarding morphological, compositional, and/or structural variations among different portions of the sample. By way of example, in some applications the methods of invention can be employed to obtain light scattering signals from cells or tissues buried under the skin.

### RELATED APPLICATION

The present application claims priority to a provisional application filed Dec. 23, 2008 entitled “Methods and System for Confocal Light Scattering Spectroscopic Imaging,” having a Ser. No. 61/140,160. This provisional application is herein incorporated by reference in its entirety.

### GOVERNMENT SPONSORED FUNDING

This invention is funded by the National Institute of Health (NIH), Grant No. R21CA114684. The Government has certain rights in this invention.

### SUMMARY

The present invention is generally directed to imaging methods and apparatus that employ angular and/or wavelength distribution of light backscattered from multiple portions of a sample in response to illumination by electromagnetic radiation to generate one, two or three dimensional images of the sample. While in some cases, an illuminating beam can be scanned along at least one dimension of a sample to obtain the backscattered spectral signals from different portions of the sample, in other cases the sample can be translated relative to a stationary beam, or a combination of the movement of the beam and the sample can be utilized. In many embodiments, confocal imaging can be employed to detect the backscattered radiation, e.g., to measure spectral signals of layered samples (such as biological samples) through optical sectioning. In some cases, polarized radiation is employed to illuminate the sample and the radiation backscattered from the sample in response to the illumination is detected at a polarization parallel and/or perpendicular to that of the illuminating radiation.

The methods of the invention can be applied to a variety of samples including, without limitation, biological and non-biological samples, organic and inorganic samples, to obtain information, e.g., regarding morphological, compositional, and/or structural variations among different portions of the sample. By way of example, in some applications the methods of invention can be employed to obtain light scattering signals from cells or tissues buried under the skin. In such cases, confocal optical sectioning can be employed to screen out photons scattered off the skin surface to detect radiation scattered by the underlying tissues, such as the dermis, blood vessels, blood flowing inside the blood vessels and muscular tissues. In some cases, the methods of the invention can be utilized to perform in-vivo flow cytometry, that is, to perform flow cytometry as the blood circulates through a live subject.

The terms “radiation” and “light” are herein utilized interchangeably, and generally refer to radiation not only in the visible portion of the electromagnetic spectrum but in any desired portion, such as the infrared. The term “backscattered radiation” is known in the art. To the extent that any further explanation may be needed, it refers to scattered radiation propagating in directions that are generally opposite to the propagation direction of the excitation radiation. A backscattered direction can be exactly opposite to the propagation direction of the excitation radiation. Alternatively, a backscattered propagation direction can form a non-zero angle (less than 90 degrees) relative to the excitation direction. In many cases, the backscattered radiation is substantially contained within a solid angle whose central axis is formed by a direction exactly opposite to that of the excitation radiation. Further, the term “confocal detection” is known in the art and to the extent that any further explanation may be required in the present context it can refer to detecting the backscattered radiation in a plane that is optically conjugate relative to a plane of the illuminating radiation.

In one aspect, an imaging method is disclosed that includes focusing illuminating radiation into a sample, and scanning the focused radiation so as to successively illuminate a plurality of sample portions. The backscattered radiation from the illuminated sample portions can be detected, preferably confocally, and the detected radiation can be analyzed to form a backscattered spectral image of the sample. In some cases, an illuminated sample portion can have a volume in a range of about 2 μm³ (micrometer cubed) to about 250,000 μm³, and preferably in a range of about 1000 μm³ to about 10,000 μm³. A variety of illumination wavelengths can be employed. By way of example, in some embodiments, the illuminating radiation can have one or more wavelengths in a range of about 400 nm to about 750 nm. In some cases, the spectral image can be in the form of a map indicating, for each of a plurality of sample portions, the angular dependence of a plurality of wavelengths in the radiation backscattered from that sample portion. In some cases, the spectral image can provide, for each of a plurality of sample portions, the wavelength dependence of radiation backscattered from the sample portion integrated over a plurality of angular locations.

In some cases in which the illuminating radiation comprises a plurality of wavelengths, the detected backscattered radiation from different sample portions can be analyzed to determine the wavelength dependence of the backscattered radiation originating from each of those sample portions. Alternatively, a plurality of sources (e.g., lasers) each of which generates radiation with a narrow wavelength band can be employed to obtain wavelength dependence of the backscattered radiation from different sample portions. For example, the backscattered radiation intensity corresponding to each wavelength for a plurality of sample portions can be obtained to derive a backscattered spectral image of the sample. In some cases, the wavelength dependence of the backscattered light at a plurality of angular locations can be determined, for each of a plurality of sample portions, to generate for each sample portion a two-dimensional spectral image in the form of wavelength intensity as a function of backscattered angular location. In some cases, the intensities of the wavelength components backscattered from a sample portion can be summed (e.g., integrated) over a plurality of angular locations to obtain wavelength dependence of the overall backscattered light intensity from that sample portion. In some cases, such wavelength dependences of different sample portions can be compared with one another to glean information regarding, e.g., compositional, morphological and/or structural variations among those sample portions.

In some cases, the angular distribution of broadband radiation backscattered from each of a plurality of sample portions can be measured and utilized to form a backscattered image of the sample. In some embodiments, both the wavelength dependence and angular distribution of the backscattered light originating from a plurality of sample portions in response to illuminating radiation can be utilized to form a backscattering image of the sample.

In some embodiments, the wavelength dependence and/or the angular dependence of light backscattered from a plurality of sample portions can be compared to differentiate material compositions of those portions. By way of example, such comparison of the spectral and/or angular characteristics of the backscattered radiation can be employed to distinguish between different types of tissue (e.g., healthy tissue relative to cancerous tissue).

In another aspect, a method for imaging a sample is disclosed that includes illuminating a plurality of sample portions with radiation at two or more wavelengths, and confocally detecting backscattered radiation generated from a plurality of the illuminated sample portions in response to each illuminating wavelength at a plurality of angular locations. The detected backscattered radiation can be utilized to generate a map indicating the intensity of the backscattered radiation for each illuminating wavelength at a plurality of angular locations. The map can be employed to compare compositional, morphological and/or structural characteristics of at least two of the sample portions (e.g., the morphology of one or more constituents of those portions).

In a related aspect, in the above method, the focused beam is generated by an optical focusing system having a numerical aperture in a range of about 0.3 to about 1.3, and the focused beam can exhibit a cross-sectional area in a range of about 0.04 μm² to about 900 μm² at its focal plane.

In some cases, in the above method, illuminating the sample at a plurality of wavelengths can be accomplished by providing a broadband radiation source (e.g., a Xenon lamp) and successively coupling each of a plurality of filters to the source to generate two or more radiation wavelengths for illuminating the sample.

### BRIEF DESCRIPTION OF THE DRAWINGS

FIG. 1 schematically depicts a light scattering spectroscopy (LSS) system according to an embodiment of the invention,

FIG. 2 schematically depicts an example of an aggregate sample, including leukemia cancer cells (NALM-6) placed on top of a highly scattering solution to which green food coloring was added as an absorber, that can be interrogated via confocal optical sectioning in accordance with the teachings of the invention,

FIG. 3A shows a sample backscattering image (map) typical of NALM-6 cells on the top layer of the aggregate sample described in connection with FIG. 2 taken at 530 nm,

FIG. 3B shows a backscattering map of the highly scattering and absorbing solution on the bottom layer of the aggregate sample described in connection with FIG. 2 taken at 530 nm,

FIG. 3C depicts spectral dependence of the overall backscattering intensity of a number of samples interrogated by using a system according to an embodiment of the invention,

FIG. 4 schematically depicts a light scattering spectroscopy (LSS) system according to another embodiment of the invention,

FIG. 5A depicts a zenith angle versus wavelength scattering map of a NALM-6 cells forming a top layer of an aggregate sample described in connection with FIG. 2, which was obtained at an azimuthal angle of about 45° by using an LLS system in accordance with the embodiment of FIG. 4,

FIG. 5B depicts a zenith angle versus wavelength scattering map of a highly scattering and absorbing layer forming a bottom layer of an aggregate sample described in connection with FIG. 2, which was obtained at an azimuthal angle of about 45° by using an LLS system in accordance with the embodiment of FIG. 4, and

FIG. 5C shows the spectral dependence of the integrated backscattering intensity for the aggregate sample corresponding to FIGS. 5A and 5B, as well as the integrated backscattering intensity for the NALM-6 cells alone, and for the highly scattering and absorbing layer alone.

### DETAILED DESCRIPTION

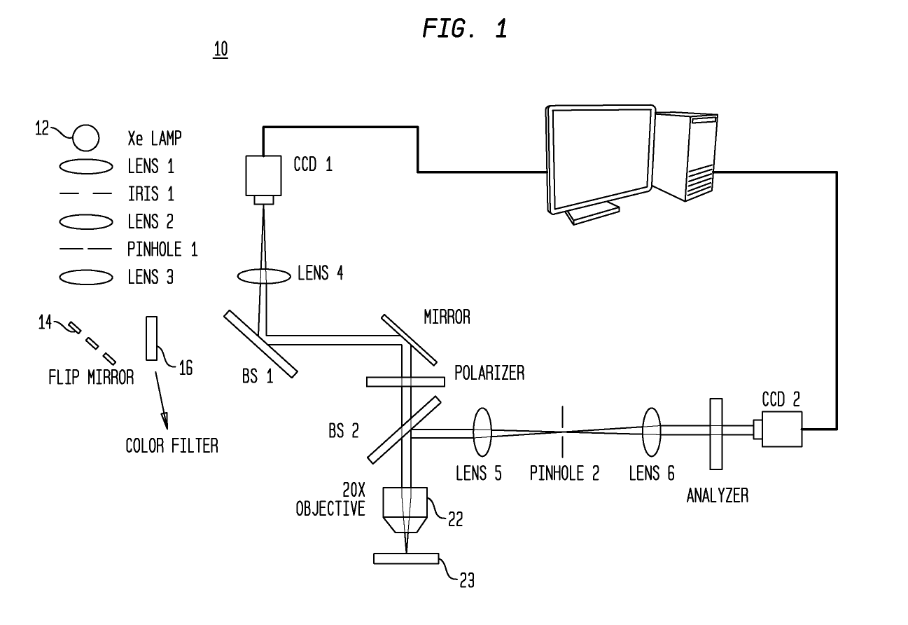

FIG. 1 schematically depicts a light scattering spectroscopy (LSS) system 10 according to an exemplary embodiment of the invention that includes confocal optical sectioning capability. The exemplary system 10 includes an illumination source 12, e.g., a 500-Watt Xenon lamp in this implementation, whose emitted light is spatially filtered and collimated by employing a combination of three lenses (Lens 1, Lens 2 and Lens 3), and an iris (Iris 1) and a pinhole (Pinhole 1). In this implementation, the white light emitted by the xenon lamp is collimated and directed—via a flip mirror 14—through a color filter wheel 16 for selecting each of a number of illumination wavelengths. The light then passes through a beam splitter (BS1) and is directed via reflection from a mirror 18 to a polarizer 20. The passage of the light through the polarizer causes the light to be polarized and the polarized light passes through another beam splitter (BS2) to a microscope objective 22 (a 20× microscope objective in this implementation), which generates a convergent beam to be focused onto a sample 23 (e.g., a sample of living cells).

Visual images of the sample can be formed via impingement of a portion of the light reflected/scattered from the sample onto a CCD camera (CCD1) via the microscope objective 22 and a lens (Lens 4). This imaging capability can be employed for visual confirmation of proper sample placement within the field of view and at the focal plane of the microscope objective.

The radiation backscattered from the sample in response to the illuminating radiation is collected by the microscope objective 22 and is directed via the beam splitter BS2 onto a two-lens combination (Lens 5 and Lens 6), which in turn directs the light toward another CCD camera (CCD 2). To reduce the detection of back-scattered light originating from out-of-focus portions of the sample (i.e., the portions not within the focal volume of the illuminating radiation focused into the sample), confocal imaging is achieved by placing a pinhole at the back focal plane of the lens 5. In this exemplary implementation a 200 μm pinhole at the back focal plane of lens 5 is employed, which can result in an axial resolution of about 30 μm and a lateral imaging field of 20 μm in diameter.

An analyzer 24 disposed between the lens 6 and the CCD 2 camera having a polarization axis that is perpendicular relative to that of the polarizer in the illumination path is employed to detect backscattered light having a polarization perpendicular to that of the polarized incident light.

In this implementation the sample is moved in a direction substantially parallel to the beam to illuminate different portions of the sample at different depths. In other cases, the sample can remain stationary while the beam is moved. Alternatively, both the sample and the beam can be moved to illuminate different portions of the sample.

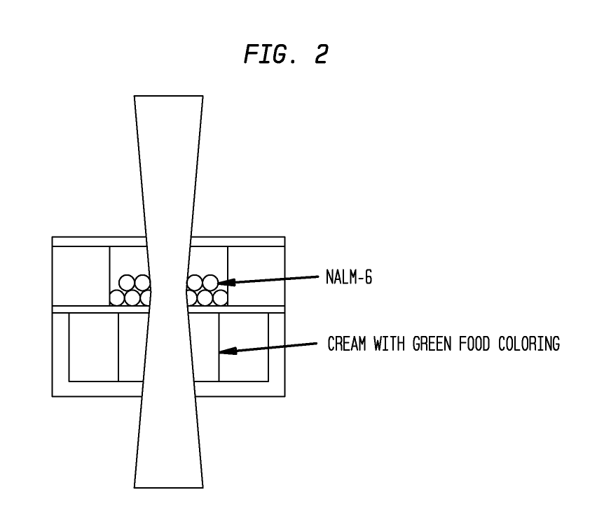

By way of illustration of the ability of the above exemplary system 10 in providing confocal optical sectioning, backscattering signals from an aggregate sample schematically depicted in FIG. 2 was collected. The aggregate sample includes layers of leukemia cancer cells (NALM-6) placed on top of a highly scattering solution to which green food coloring has been added as an absorber. To prepare the sample, human leukemia cells (NALM-6) were placed in a glass-made cell chamber and allowed to settle to the glass bottom to form a 200-μm thick layer. Simultaneously, a batch of dairy cream, simulating a highly scattering medium, was dyed with a green food coloring and placed in another liquid holder.

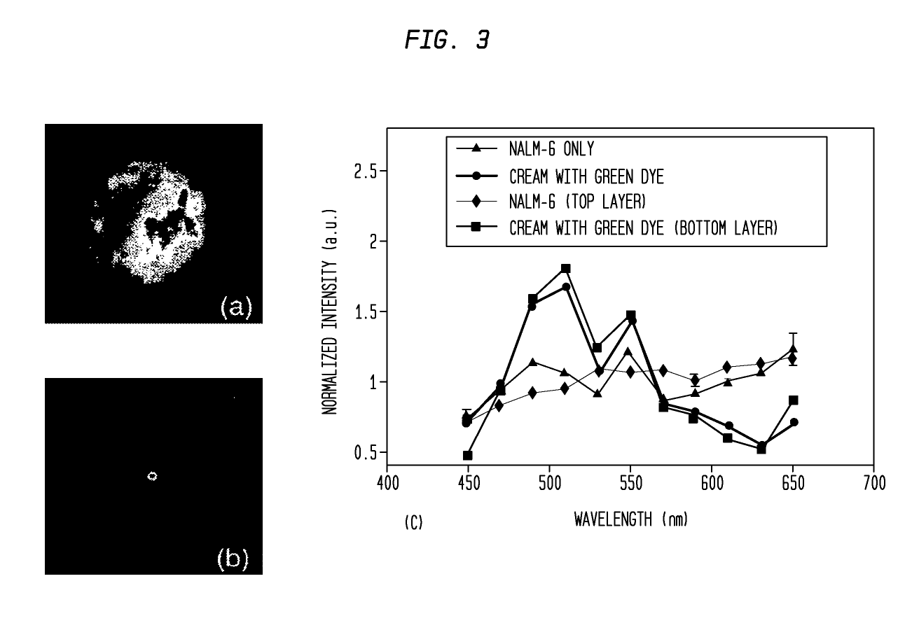

The spectral characteristics of the NALM-6 and green scattering solution were separately captured using the above LSS system 10. The two samples were then stacked on top of each other, as shown schematically in FIG. 2, with the NALM-6 cell layers and the green solution separated by a glass coverslip. The light backscattering spectral signals of the stacked NALM-6 cell layers and the green solution were then captured. The results are shown in FIGS. 3A-3C. More specifically, FIG. 3A shows a sample backscattering image (map) typical of the NALM-6 cells on the top layer taken at 530 nm. FIG. 3B shows a backscattering map of the highly scattering and absorbing solution on the bottom layer taken at 530 nm. The spectral dependence of the overall backscattering intensity of each sample is shown in FIG. 3C. The overall backscattering intensity was determined as the sum of counts in all pixels on each image except the central region of the image (i.e., the region representing angles from about −2 to about 2 degrees) where the back-reflection of the objective lens dominates. FIG. 3C demonstrates that the exemplary confocal system is capable of screening out the light scattering signals from the NALM-6 cells on top and retrieving the light scattering signals from the highly scattering and absorbing solution on the bottom.

In the above implementation the sample was scanned in one dimension to acquire depth-resolved information. In other implementations, the sample can remain stationary while the light beam is scanned. Two or three-dimensional light scattering spectral image stacks can also be acquired by either scanning a specimen and/or the light in two or three dimensions.

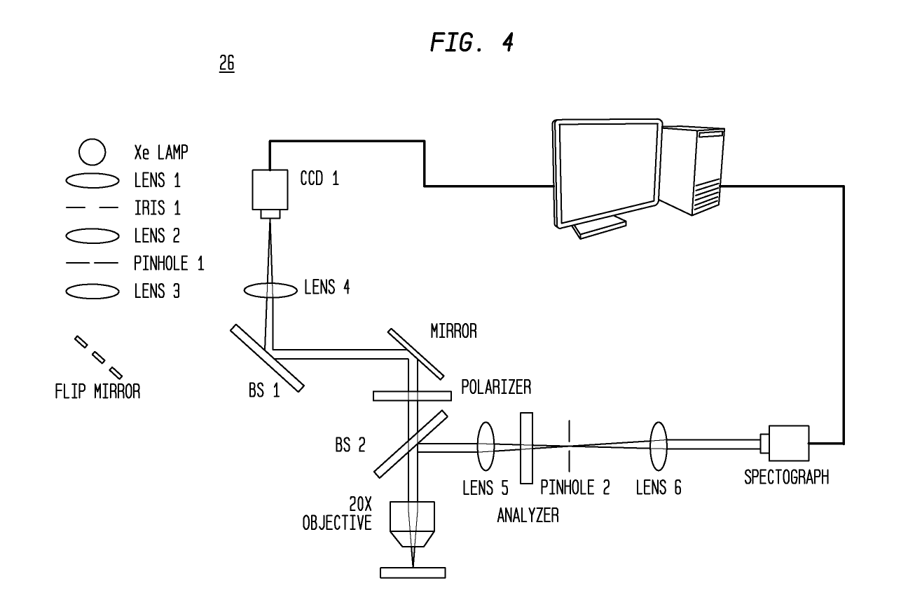

FIG. 4 schematically depicts an LLS system 26 according to another embodiment of the invention that illuminates the sample with a broad spectrum illumination (unlike the previous embodiment, it lacks a color filter to extract desired light wavelengths from light emitted by a broad spectrum source), and employs a spectrograph placed in front of a detector (e.g., a CCD camera) to obtain the intensity of different wavelengths present in the backscattered radiation.

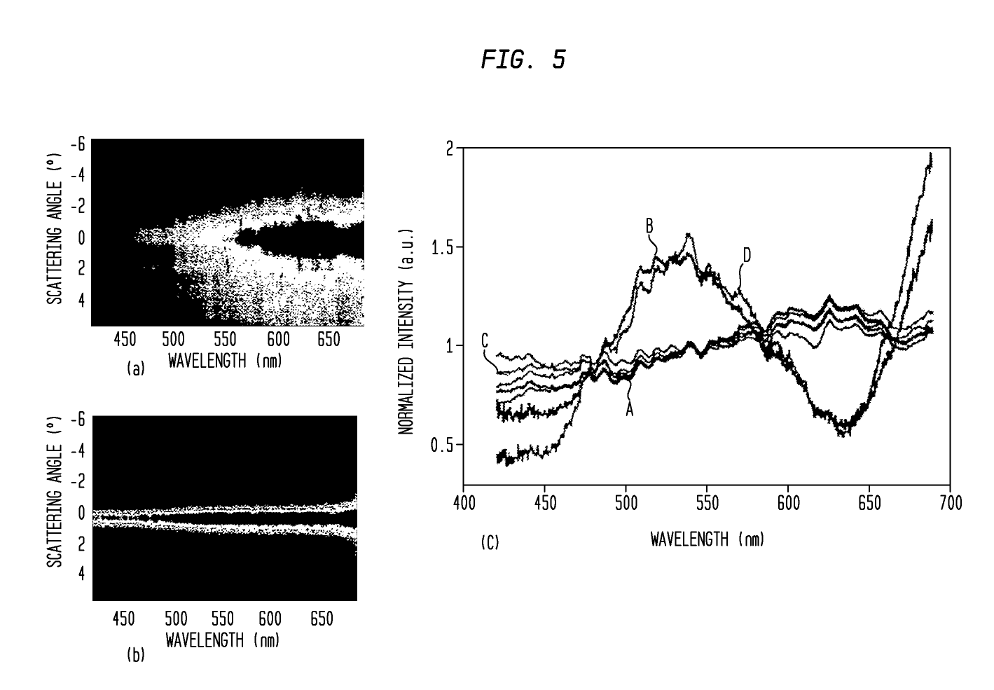

FIGS. 5A-5C show the exemplary data obtained for the sample shown in FIG. 2 by employing the exemplary LLS system 26 depicted schematically in FIG. 4. FIG. 5A depicts the zenith angle versus wavelength scattering map of the NALM-6 cells on the top layer while FIG. 5B shows a corresponding scattering map for the cream layer with green food coloring on the bottom. Both maps were obtained at an azimuthal angle of about 45°.

FIG. 5C shows the spectral dependence of the integrated backscattering intensity for NALM-6 cells alone (solid line A), cream with green food coloring alone (solid line B), and the stacked NALM-6 (solid line C) and green cream (solid line D). The integrated backscattering intensity was obtained as the sum of signal intensity from zenith angle of about −4° to zenith angle of about −6°. The results shown in FIG. 5C again demonstrate the confocal sectioning ability of an exemplary implementation of the LLS system.

The teachings of U.S. Pat. No. 7,264,794 entitled “Methods Of In Vivo Cytometry” is herein incorporated by reference in its entirety.

Those having ordinary skill in the art will appreciate that various changes can be made to the above embodiments without departing from the scope of the invention.

1. An imaging method, comprising
focusing illuminating radiation into a sample,
scanning said focused radiation so as to successively illuminate a plurality of sample portions,
confocally detecting backscattered radiation originating from each of said sample portions in response to said illuminating radiation, and
analyzing said backscattered radiation to generate a spectral image of said sample.

2. The method of claim 1, wherein said spectral image is any of a one-dimensional, two-dimensional or three-dimensional spectral image.

3. The method of claim 1, further comprising utilizing said spectral image to compare any of compositions, morphologies or structures of at least two of said sample portions.

4. The method of claim 1, wherein said illuminating radiation comprises a plurality of wavelengths.

5. The method of claim 1, wherein the step of confocally detecting the backscattered radiation originating from one or more of said sample portions comprises detecting the backscattered radiation corresponding to each of said illuminating wavelengths.

6. The method of claim 5, wherein the step of comparing the backscattered radiation comprises comparing wavelength dependence of the detected backscattered radiation originating from said two portions for differentiating the material compositions of said two portions.

7. The method of claim 5, wherein the step of confocally detecting the backscattered radiation originating from each of said sample portions comprises detecting said backscattered radiation for at least two of the illuminating wavelengths at two or more angular locations.

8. A method for imaging a sample, comprising
illuminating a plurality of sample portions with radiation at two or more wavelengths,
confocally detecting backscattered radiation generated from each sample portion in response to each illuminating wavelength at a plurality of angular locations,
generating a map indicative of intensity of the detected backscattered radiation for each illuminating wavelength at a plurality of angular locations.

9. The method of claim 8, wherein the illuminating the step comprises scanning an illumination beam along at least one dimension of the sample.

10. The method of claim 9, wherein scanning the beam comprises moving the beam relative to the sample.

11. The method of claim 9, wherein scanning the beam comprises moving the sample relative to the beam.

12. The method of claim 8, further comprising utilizing said map to compare compositional characteristics of at least two of said sample portions.

13. The method of claim 8, further comprising utilizing said map to compare morphological characteristics of at least two of said sample portions.

14. The method of claim 8, further comprising utilizing said map to compare structural characteristics of at least two of said sample portions.

15. The method of claim 8, wherein the step of illuminating a plurality of sample portions comprises
generating a focused beam of radiation, and
scanning said focused beam so as to successively illuminate said sample portions.

16. The method of claim 15, wherein said focused beam is generated by an optical focusing system having a numerical aperture in a range of about 0.3 to about 1.3.

17. The method of claim 15, wherein said focused beam exhibits a cross-sectional area in a range of about 0.04 μm² to about 900 μm² at its focal plane.

18. The method of claim 15, wherein the step of scanning the focused beam comprises scanning the beam along one dimension of the sample.

19. The method of claim 15, wherein the step of scanning the focused beam comprises scanning the beam along two dimensions of the sample.

20. The method of claim 15, wherein the step of scanning the focused beam comprises scanning the beam along three dimensions of the sample.

21. The method of claim 8, wherein the step of illuminating the sample further comprises
providing a source of broadband radiation,
successively coupling each of a plurality of filters to said source to generate two or more radiation wavelengths for illuminating the sample.

22. The method of claim 21, wherein said broadband source comprises a xenon lamp.

23. The method of claim 8, wherein said sample comprises biological constituents.

24. The method of claim 23, wherein said sample comprises stacked layers of biological issue.

25. The method of claim 8, further comprising utilizing a polarizer to polarize said illuminating radiation.

26. The method of claim 17, further comprising detecting the backscattered radiation at a polarization normal to the polarization of said polarized illuminating radiation.

27. An imaging method, comprising
focusing illuminating radiation into a sample,
scanning said focused radiation so as to successively illuminate a plurality of sample portions,
confocally detecting backscattered radiation originating from each of said sample portions in response to said illuminating radiation, and
comparing the backscattered radiation originating from at least two different sample portions to differentiate any of composition, morphology and/or structure of said sample portions
